(19) United States
(12) Patent Application Publication
(10) Pub. No.: US 2017/0120768 A1
(43) Pub. Date: May 4, 2017

(54) ELECTRIC QUANTITY MONITORING DEVICE, NAVIGATION SYSTEM AND VEHICLE

(71) Applicant: Leauto Intelligent Technology (BEIJING) Co. Ltd., Beijing (CN)

(72) Inventor: Jialin Zhang, Beijing (CN)

(21) Appl. No.: 14/981,373

(22) Filed: Dec. 28, 2015

(30) Foreign Application Priority Data
Nov. 2, 2015 (CN) 201510733042.0

(51) Int. Cl. B60L 11/18; B60R 16/03

(52) U.S. Cl. CPC B60L 11/1862; B60R 16/03

(57) ABSTRACT

The disclosure describes embodiments of an electric quantity monitoring device and vehicle. In some embodiments, the electric quantity monitoring device comprises a switching circuit, processor, memory, and communication circuit, wherein the switching circuit awakens the processor when arriving at a cycle, and then the processor in the awakened state acquires the remaining electric quantity of a vehicle-mounted power supply of a vehicle through a CAN bus; on the one hand, if the remaining electric quantity is lower than a threshold electric quantity, the communication circuit sends the remaining electric quantity to a pre-stored mobile phone number, and the processor restores a dormant state after the communication circuit sends the remaining electric quantity; on the other hand, if the remaining electric quantity is not lower than the threshold electric quantity, the processor restores the dormant state, thus achieving monitoring of the electric quantity of the vehicle-mounted battery of the electric vehicle.

### CROSS-REFERENCE TO RELATED APPLICATIONS

This application claims the benefit of Chinese Patent Application No. 201510733042.0, filed on Nov. 02, 2015, and which is hereby incorporated by reference in its entirety.

### BACKGROUND

Field

The present disclosure relates to an electronic technology, and particularly relates to an electric quantity monitoring device, a navigation system and a vehicle.

Description of Related Art

With increasing prominence of environmental issues and continuous development of vehicle manufacture, electric vehicles have increasingly attracted people's attention, due to adopting clean energy and having relatively low pollution to the environment. The electric vehicles are vehicles that are powered by vehicle-mounted power supplies, have wheels driven by motors to run and accord with various requirements of road traffic and safety regulations.

However, the power consumption of the existing electric vehicles is relatively high even in a stop state, so that after being parked for long time, the electric vehicles often cannot be started due to power exhaustion of the vehicle-mounted power supplies, and even vehicle keys cannot be identified due to power failure or low power, and vehicle doors cannot be opened, so great inconvenience is brought to users.

### SUMMARY

Embodiments of the present disclosure provide an electric quantity monitoring device for monitoring the electric quantity of a vehicle-mounted battery of an electric vehicle, a navigation system and a vehicle.

In order to achieve the above object, the embodiments of the present disclosure adopt the following technical solutions:

In one aspect, provided is an electric quantity monitoring device, including a switching circuit, a processor, a memory and a communication circuit, wherein the processor is respectively electrically connected with the switching circuit and the communication circuit, and the communication circuit is electrically connected with the memory;

the switching circuit is used for awakening the processor when arriving at a timing cycle;

the processor is used for, when being in the awakened state, if the vehicle state acquired through a controller area network (CAN) bus of a vehicle is in a stop state, acquiring the remaining electric quantity of a vehicle-mounted power supply of the vehicle through the CAN bus; if the remaining electric quantity is lower than a threshold electric quantity, sending the remaining electric quantity to the communication circuit, and restoring a dormant state after the communication circuit sends the remaining electric quantity; and if the remaining electric quantity is not lower than the threshold electric quantity, restoring the dormant state;

the memory is used for pre-storing a mobile phone number; and

the communication circuit is used for sending the remaining electric quantity to the mobile phone number pre-stored in the memory.

In another aspect, provided is a navigation system, including the electric quantity monitoring device as described above.

In a further aspect, provided is a vehicle, including the electric quantity monitoring device as described above.

The electric quantity monitoring device in one or more embodiments includes a switching circuit, a processor, a memory and a communication circuit, wherein the switching circuit awakens the processor when arriving at the timing cycle, and then the processor in the awakened state acquires the remaining electric quantity of the vehicle-mounted power supply of the vehicle through the CAN bus; on the one hand, if the remaining electric quantity is lower than the threshold electric quantity, the communication circuit sends the remaining electric quantity to the pre-stored mobile phone number, and the processor restores the dormant state after the communication circuit sends the remaining electric quantity; on the other hand, if the remaining electric quantity is not lower than the threshold electric quantity, the processor restores the dormant state, thus achieving monitoring of the electric quantity of the vehicle-mounted battery of the electric vehicle. Meanwhile, when the vehicle is in the stop state, the electric quantity monitoring device is cyclically awakened to monitor the electric quantity, so the power consumption of the electric quantity monitoring device itself is reduced.

### BRIEF DESCRIPTION OF THE DRAWINGS

FIG. 1 is a structural schematic diagram of an electric quantity monitoring device provided according to embodiment 1 of the present disclosure.

FIG. 2 is a structural schematic diagram of another electric quantity monitoring device provided according to embodiment 2 of the present disclosure.

FIG. 3 is a diagram of circuit connection relation of the electric quantity monitoring device.

### DETAILED DESCRIPTION

An electric quantity monitoring device, a navigation system and a vehicle provided by the embodiments of the present disclosure will be described in detail below in combination with the accompanying drawings.

### Embodiment 1

FIG. 1 is a structural schematic diagram of an electric quantity monitoring device provided by embodiment 1 of the present disclosure. The electric quantity monitoring device is installed inside a vehicle and is connected with a CAN bus of the vehicle. Specifically, the vehicle may be an electric vehicle, as shown in FIG. 1, including a switching circuit 11, a processor 12, a memory 13 and a communication circuit 14.

The processor 12 is electrically connected with the switching circuit 11 and the communication circuit 14, and the communication circuit 14 is electrically connected with the memory 13. The processor 12 may be a power management chip of a navigation system of the vehicle.

The switching circuit 11 is used for awakening the processor 12 when arriving at a timing cycle.

The processor 12 is used for, when being in the awakened state, if the vehicle state acquired through a CAN bus of the vehicle is in a stop state, acquiring the remaining electric quantity of a vehicle-mounted power supply of the vehicle through the CAN bus of the vehicle; if the remaining electric quantity is lower than a threshold electric quantity, sending the remaining electric quantity to the communication circuit 14, and restoring a dormant state after the communication circuit 14 sends the remaining electric quantity; and if the remaining electric quantity is not lower than the threshold electric quantity, restoring the dormant state.

The value range of the threshold electric quantity is 10-30%, and preferably may be 20%. The value range may be determined in conjunction with the arrangement density of charging devices within the vehicle travelling range; if the arrangement density is relatively large, the value of the threshold electric quantity can be relatively low; otherwise, the value can be relatively high.

The memory 13 is used for pre-storing a mobile phone number.

The communication circuit 14 is used for sending the remaining electric quantity to the mobile phone number pre-stored in the memory 13.

The communication circuit 14 is specifically used for receiving the remaining electric quantity sent by the processor 12, reading the pre-stored mobile phone number from the memory 13, sending the remaining electric quantity to the mobile phone number in the form of a short message through a base station, and after receiving a sending success response sent by the base station, sending the sending success response to the processor 12.

Specifically, after the user stops the vehicle, the processor 12 in the electric quantity monitoring device of this embodiment acquires an engine shutdown signal through the CAN bus, the processor instructs the switching circuit 11 to start, and the switching circuit 11 awakens the processor 12 when arriving at the timing cycle. Further, the processor 12 acquires the remaining electric quantity of the vehicle-mounted power supply of the vehicle through the CAN bus, and judges the remaining electric quantity.

On the one hand, if the remaining electric quantity is lower than the threshold electric quantity, the processor 12 sends the remaining electric quantity to the communication circuit 14, and restores the dormant state after the communication circuit 14 sends the remaining electric quantity.

The processor 12 is specifically used for acknowledging, by receiving the sending success response sent by the communication circuit 14, that the communication circuit 14 has sent the remaining electric quantity, and then executing a shutdown process to restore the dormant state.

On the other hand, if the remaining electric quantity is not lower than the threshold electric quantity, the processor 12 restores the dormant state.

The processor 12 is specifically used for executing a shutdown process to restore the dormant state.

In this embodiment, the electric quantity monitoring device includes a switching circuit, a processor, a memory and a communication circuit, wherein the switching circuit awakens the processor when arriving at the timing cycle, and then the processor in the awakened state acquires the remaining electric quantity of the vehicle-mounted power supply of the vehicle through the CAN bus; on the one hand, if the remaining electric quantity is lower than the threshold electric quantity, the communication circuit sends the remaining electric quantity to the pre-stored mobile phone number, and the processor restores the dormant state after the communication circuit sends the remaining electric quantity; on the other hand, if the remaining electric quantity is not lower than the threshold electric quantity, the processor restores the dormant state, and thus achieving monitoring of the electric quantity of the vehicle-mounted battery of the electric vehicle. Meanwhile, when the vehicle is in the stop state, the electric quantity monitoring device is cyclically awakened to monitor the electric quantity, so the power consumption of the electric quantity monitoring device itself is reduced. In addition, the user is informed only when the remaining electric quantity is relatively low, so the power consumption of the electric quantity monitoring device itself is further reduced, and power exhaustion of the vehicle-mounted power supply is avoided.

### Embodiment 2

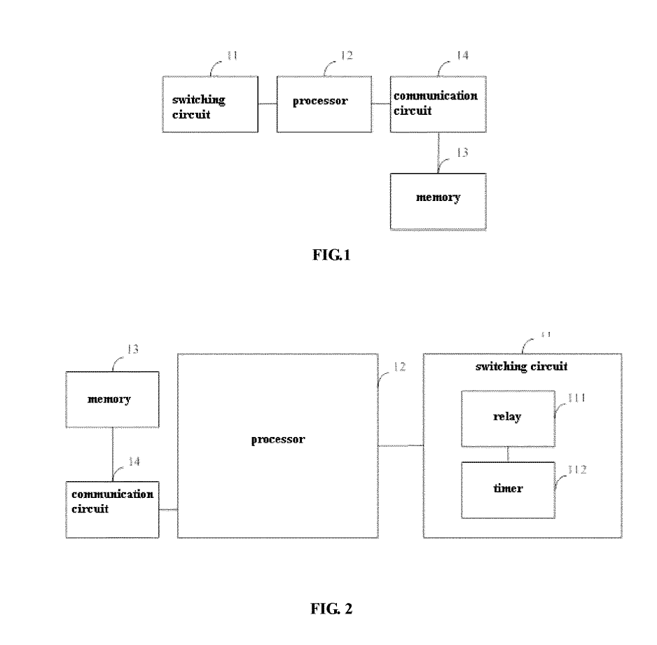

FIG. 2 is a structural schematic diagram of another electric quantity monitoring device provided by embodiment 2 of the present disclosure. As shown in FIG. 2, on the basis of embodiment 1, the switching circuit 11 in this embodiment further includes a relay 111 and a timer 112.

The relay 111 is electrically connected with the timer 112.

The timer 112 is used for, when arriving at the timing cycle, sending an indicating signal to the relay 111.

The relay 111 is used for, after receiving the indicating signal, continuing the electrical connection between the vehicle-mounted battery of the vehicle and the processor 12, to awaken the processor 12.

Specifically, the timing cycle may be an hour; every hour, the relay 111 continues the electrical connection between the vehicle-mounted battery and the processor 12 so as to trigger the processor 12 to enter the awakened state to execute subsequent steps of acquiring the remaining electric quantity of the vehicle-mounted power supply of the vehicle through the CAN bus; if the remaining electric quantity is lower than the threshold electric quantity, sending the remaining electric quantity to the communication circuit 14, and restoring the dormant state after the communication circuit 14 sends the remaining electric quantity; and if the remaining electric quantity is not lower than the threshold electric quantity, restoring the dormant state.

The timer 112 triggers the relay 111 every hour to awaken the processor 12 once, and regardless of the remaining electric quantity of the vehicle-mounted battery, the processor 12 restores dormancy after monitoring the remaining electric quantity, so that the power consumption of the electric quantity monitoring device itself is reduced.

In this embodiment, the electric quantity monitoring device includes a switching circuit, a processor, a memory and a communication circuit, wherein the switching circuit awakens the processor when arriving at the timing cycle, and then the processor in the awakened state acquires the remaining electric quantity of the vehicle-mounted power supply of the vehicle through the CAN bus; on the one hand, if the remaining electric quantity is lower than the threshold electric quantity, the communication circuit sends the remaining electric quantity to the pre-stored mobile phone number, and the processor restores the dormant state after the communication circuit sends the remaining electric quantity; on the other hand, if the remaining electric quantity is not lower than the threshold electric quantity, the processor restores the dormant state, and thus achieving monitoring of the electric quantity of the vehicle-mounted battery of the electric vehicle. Meanwhile, when the vehicle is in the stop state, the electric quantity monitoring device is cyclically awakened to monitor the electric quantity, so the power consumption of the electric quantity monitoring device itself is reduced. In addition, the user is informed only when the remaining electric quantity is relatively low, so the power consumption of the electric quantity monitoring device itself is further reduced, and power exhaustion of the vehicle-mounted power supply is avoided.

### Embodiment 3

In the electric quantity monitoring device of this embodiment, on the basis of the electric quantity monitoring device provided by embodiment 1 or 2, the processor 12 is further used for, if the remaining electric quantity is lower than the threshold electric quantity, instructing the switching circuit to stop awakening the processor.

Specifically, the processor 12 is used for, if the remaining electric quantity is lower than the threshold electric quantity, deleting the timing cycle set in the switching circuit 11, to stop awakening of the processor 12 by the switching circuit 11.

The processor 12 sends the remaining electric quantity to the communication circuit 14 if acknowledging that the remaining electric quantity is lower than the threshold electric quantity, meanwhile, deletes the timing cycle set in the switching circuit 11 to stop awakening of the processor 12 by the switching circuit 11, and restores the dormant state after the communication circuit 14 sends the remaining electric quantity.

When the remaining electric quantity is relatively low, not only does the processor 12 restore dormancy after acknowledging that the user is successfully informed, but also cyclically awakening of the processor 12 by the switching circuit 11 is stopped, so as to further reduce its power consumption, and avoid power exhaustion of the vehicle-mounted power supply.

Further, the processor 12 is also used for, if the vehicle state acquired through the CAN bus is in a running state, instructing the switching circuit 11 to stop awakening the processor 12, acquiring the remaining electric quantity of the vehicle-mounted power supply of the vehicle in real time through the CAN bus, and if the remaining electric quantity is lower than the threshold electric quantity, sending the remaining electric quantity to the communication circuit 14.

Specifically, when the vehicle is in the running state, the processor 12 instructs the switching circuit 11 to stop awakening the processor 12, acquires the remaining electric quantity of the vehicle-mounted power supply of the vehicle in real time through the CAN bus, and if the remaining electric quantity is lower than the threshold electric quantity, sends the remaining electric quantity to the communication circuit 14, so that the communication circuit 14 sends the remaining electric quantity to the mobile phone number pre-stored in the memory 13.

When the vehicle is in the running state, the processor 12 monitors the electric quantity in real time, because the power consumption is relatively high and the electric quantity may drop quickly within a short time during running of the vehicle, and thus cyclic monitoring can no longer meet the monitoring requirement, and has to be changed to real-time monitoring of the electric quantity to timely inform the user when the remaining electric quantity is insufficient.

This embodiment further provides a navigation system, including the electric quantity monitoring device in this embodiment, wherein the processor 12 in the electric quantity monitoring device specifically may be a power management chip of the navigation system.

In this embodiment, the electric quantity monitoring device includes a switching circuit, a processor, a memory and a communication circuit, wherein the switching circuit awakens the processor when arriving at the timing cycle, and then the processor in the awakened state acquires the remaining electric quantity of the vehicle-mounted power supply of the vehicle through the CAN bus; on the one hand, if the remaining electric quantity is lower than the threshold electric quantity, the communication circuit sends the remaining electric quantity to the pre-stored mobile phone number, and the processor restores the dormant state after the communication circuit sends the remaining electric quantity; on the other hand, if the remaining electric quantity is not lower than the threshold electric quantity, the processor restores the dormant state, and thus achieving monitoring of the electric quantity of the vehicle-mounted battery of the electric vehicle. Meanwhile, when the vehicle is in the stop state, the electric quantity monitoring device is cyclically awakened to monitor the electric quantity, so the power consumption of the electric quantity monitoring device itself is reduced. In addition, during running of the vehicle, the power consumption is relatively high, the electric quantity may drop quickly within a short time, and thus, cyclic monitoring no longer meets the monitoring requirement, and the electric quantity monitoring device monitors the electric quantity in real time when the vehicle is in the running state, so as to timely inform the user when the remaining electric quantity is insufficient.

### Embodiment 4

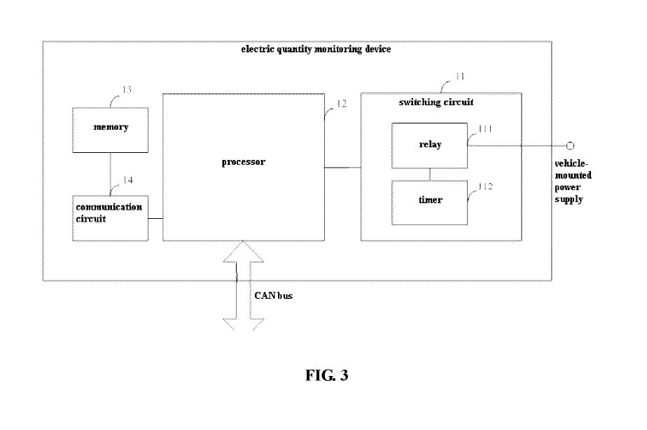

This embodiment provides a vehicle, which may be an electric vehicle, and one of the electric quantity monitoring devices provided by the aforementioned embodiments is installed inside the vehicle. FIG. 3 is a diagram of circuit connection relation of the electric quantity monitoring device. As shown in FIG. 3, the processor 12 in the electric quantity monitoring device is connected with the CAN bus of the vehicle, and the switching circuit 11 is electrically connected with the vehicle-mounted power supply, wherein the processor in the electric quantity monitoring device specifically may be a power management chip of a navigation system of the vehicle.

Specifically, after the engine of the vehicle stops operation, the CAN bus sends an engine shutdown signal, the processor 12 in the electric quantity monitoring device instructs the switching circuit 11 to start after receiving the engine shutdown signal, and the switching circuit 11 awakens the processor 12 when arriving at the timing cycle. Further, the processor 12 acquires the remaining electric quantity of the vehicle-mounted power supply of the vehicle through the CAN bus, and judges the remaining electric quantity. On the one hand, if the remaining electric quantity is lower than the threshold electric quantity, the processor 12 sends the remaining electric quantity to the communication circuit 14, meanwhile, deletes the timing cycle set in the switching circuit 11 to stop awakening of the processor 12 by the switching circuit 11, and restores the dormant state after the communication circuit 14 sends the remaining electric quantity. On the other hand, if the remaining electric quantity is not lower than the threshold electric quantity, the processor 12 restores the dormant state.

The timer 112 triggers the relay 111 at each timing cycle to awaken the processor 12 once, and regardless of the remaining electric quantity of the vehicle-mounted battery, the processor 12 restores dormancy after monitoring the remaining electric quantity, so the power consumption of the electric quantity monitoring device itself is reduced. In addition, when the remaining electric quantity is relatively low, not only does the processor 12 restore dormancy after acknowledging that the user is successfully informed, but also cyclically awakening of the processor 12 by the switching circuit 11 is stopped, so as to further reduce the power consumption of the electric quantity monitoring device itself, and avoid power exhaustion of the vehicle-mounted power supply.

Further, specifically, when the vehicle is in the running state, the CAN bus sends an engine start signal, and the processor 12 acknowledges that the vehicle state is a running state through the engine start signal, instructs the switching circuit 11 to stop awakening the processor 12, acquires the remaining electric quantity of the vehicle-mounted power supply of the vehicle in real time through the CAN bus, and when the remaining electric quantity is lower than the threshold electric quantity, sends the remaining electric quantity to the communication circuit 14, so that the communication circuit 14 sends the remaining electric quantity to the mobile phone number pre-stored in the memory 13.

When the vehicle is in the running state, the processor 12 monitors the electric quantity in real time, because the power consumption is relatively high and the electric quantity may drop quickly within a short time during running of the vehicle, and thus, cyclic monitoring can no longer meet the monitoring requirement, and has to be changed to real-time monitoring of the electric quantity to timely inform the user when the remaining electric quantity is insufficient.

In this embodiment, the electric quantity monitoring device includes a switching circuit, a processor, a memory and a communication circuit, wherein the switching circuit awakens the processor when arriving at the timing cycle, and then the processor in the awakened state acquires the remaining electric quantity of the vehicle-mounted power supply of the vehicle through the CAN bus; on the one hand, if the remaining electric quantity is lower than the threshold electric quantity, the communication circuit sends the remaining electric quantity to the pre-stored mobile phone number, and the processor restores the dormant state after the communication circuit sends the remaining electric quantity; on the other hand, if the remaining electric quantity is not lower than the threshold electric quantity, the processor restores the dormant state, and thus achieving monitoring of the electric quantity of the vehicle-mounted battery of the electric vehicle. Meanwhile, when the vehicle is in the stop state, the electric quantity monitoring device is cyclically awakened to monitor the electric quantity, so the power consumption of the electric quantity monitoring device itself is reduced. In addition, during running of the vehicle, the power consumption is relatively high, the electric quantity may drop quickly within a short time, and thus, cyclic monitoring can no longer meet the monitoring requirement, and the electric quantity monitoring device monitors the electric quantity in real time when the vehicle is in the running, so that the user is informed in time when the remaining electric quantity is insufficient.

Those of ordinary skill in the art could understand that all of or part of the steps of the above method embodiments may be accomplished by program instruction related hardware. The program may be stored in a computer readable storage medium. The program when being executed, executes the steps of the method embodiments; and the storage medium includes various media capable of storing program codes, such as an ROM, an RAM, a disk or an optical disk etc.

Finally, it should be noted that the above embodiments are merely used for illustrating rather than limiting the technical solutions of the present disclosure; although the present disclosure is illustrated in detail with reference to the aforementioned embodiments, it should be understood by those of ordinary skill in the art that modifications may still be made on the technical solutions disclosed in the aforementioned embodiments, or equivalent substitutions may be made to part of or all of the technical features thereof, without making, by these modifications or substitutions, the nature of the corresponding technical solutions depart from the scope of the technical solutions of the embodiments of the present disclosure.

What is claimed is:

1. An electric quantity monitoring device, comprising:
a switching circuit;
a processor;
a memory; and
a communication circuit,
wherein:
the processor is electrically connected to the switching circuit and the communication circuit, and the communication circuit is electrically connected to the memory;
the switching circuit is configured to awaken the processor at a timing cycle;
the processor is configured to, when in an awakened state, if a vehicle state acquired through a CAN bus of a vehicle is in a stop state, acquire a remaining electric quantity of a vehicle-mounted power supply of the vehicle through the CAN bus; if the remaining electric quantity is lower than a threshold electric quantity, sending the remaining electric quantity to the communication circuit, and restoring a dormant state after the communication circuit sends the remaining electric quantity; and if the remaining electric quantity is not lower than the threshold electric quantity, restoring the dormant state;
the memory is configured to pre-store a mobile phone number; and
the communication circuit is configured to send the remaining electric quantity to the pre-stored mobile phone number in the memory.

2. The electric quantity monitoring device of claim 1, wherein the switching circuit comprises a relay and a timer,
the relay electrically connected to the timer,
the timer configured to, when arriving at the timing cycle, send an indicating signal to the relay,
the relay configured to, after receiving the indicating signal, relaying an electrical connection between a vehicle-mounted battery of the vehicle and the processor, to awaken the processor.

3. The electric quantity monitoring device of claim 1, wherein:
the communication circuit is further configured to receive the remaining electric quantity sent by the processor, read the pre-stored mobile phone number from the memory, send the remaining electric quantity to the pre-stored mobile phone number in a form of a short message through a base station, and after receiving a sending success response sent by the base station, sending the sending success response to the processor.

4. The electric quantity monitoring device of claim 3, wherein restoring the dormant state after the communication circuit sends the remaining electric quantity comprises:
the processor configured to, after receiving the sending success response, execute a shutdown process to restore the dormant state.

5. The electric quantity monitoring device of claim 1, wherein:
the processor is further configured to, if the remaining electric quantity is lower than the threshold electric quantity, indicate to the switching circuit to stop awakening the processor.

6. The electric quantity monitoring device of claim 5, wherein:
the processor is further configured to, if the remaining electric quantity is lower than the threshold electric quantity, delete the timing cycle set in the switching circuit to stop awakening of the processor by the switching circuit.

7. The electric quantity monitoring device of claim 1, wherein:
the processor is further configured to, if the vehicle state acquired through the CAN bus is in a running state, indicate the switching circuit to stop awakening the processor, acquiring the remaining electric quantity of the vehicle-mounted power supply of the vehicle in real time through the CAN bus, and if the remaining electric quantity is lower than the threshold electric quantity, sending the remaining electric quantity to the communication circuit.

8. The electric quantity monitoring device of claim 1, wherein a value range of the threshold electric quantity is 10-30%.

9. The electric quantity monitoring device of claim 1, wherein the processor is specifically a power management chip of a navigation system of the vehicle.

10. The electric quantity monitoring device of claim 1, further comprising a navigation system.

11. The electric quantity monitoring device of claim 1, wherein the vehicle comprises the electric quantity monitoring device of claim 1.
